(19) United States
(12) Patent Application Publication
(10) Pub. No.: US 2026/0138241 A1
(43) Pub. Date: May 21, 2026

(54) IMPACT ROTARY TOOL

(71) Applicant: Panasonic Intellectual Property Management Co., Ltd., Osaka (JP)

(72) Inventors: Ryosuke ISHIDA, Osaka (JP); Akito NAKAMURA, Mie (JP)

(21) Appl. No.: 19/381,066

(22) Filed: Nov. 6, 2025

(30) Foreign Application Priority Data
Nov. 21, 2024 (JP) 2024-203519
May 29, 2025 (JP) 2025-090052

(51) Int. Cl. B25B 21/02; B25B 23/00

(52) U.S. Cl. CPC B25B 21/02; B25B 23/0035

(57) ABSTRACT

An impact rotary tool according to the present disclosure includes a motor, an output shaft, an impact mechanism, an inner cover unit, and a body case. The impact mechanism is configured to apply impacting force to the output shaft in response to rotation of the motor. The body case houses the motor, the impact mechanism, and the inner cover unit. The impact mechanism includes a hammer member that hits, in response to the rotation of the motor, hit portion provided for the output shaft. The inner cover unit covers at least the impact mechanism.

### CROSS-REFERENCE TO RELATED APPLICATIONS

The present application is based upon, and claims the benefit of priority to, Japanese Patent Application No. 2025-090052, filed on May 29, 2025, and Japanese Patent Application No. 2024-203519, filed on November 21, 2024, the entire contents of which are hereby incorporated by reference.

### TECHNICAL FIELD

The present disclosure generally relates to an impact rotary tool, and more particularly relates to an impact rotary tool configured to cause an output shaft to rotate by applying impacting force.

### BACKGROUND ART

Literature 1 (JP 2010-280021 A) discloses an impact wrench. The impact wrench in the literature 1 includes a column-shaped spindle to be caused to rotate by a motor, an anvil, a main hammer, a sub-hammer, and a rotary impact mechanism.

The anvil is disposed forward in a direction of a rotation axis of the spindle. The anvil includes, in a front portion thereof, a hole into which a screwdriver bit is inserted, and is provided with, in the rear portion thereof, a first claw. The main hammer is fitted to an outer periphery of the spindle and provided, in the front portion thereof, with a second claw that engages with the first claw. The main hammer can rotate about the rotation axis of the spindle and move in the direction of the rotation axis of the spindle. The sub-hammer includes a circular cylindrical portion that rotates together with the main hammer. In the interior space of the circular cylindrical portion, the spindle is inserted and the main hammer is housed.

The rotary impact mechanism is interposed between the spindle and the main hammer. When torque having a torque value greater than a predetermined value is applied between the spindle and the main hammer, the rotary impact mechanism causes the main hammer to rotate and to advance toward the anvil and causes the second claw to engage impulsively with the first claw to hit the first claw, thereby causing the anvil to rotate about the rotation axis.

### SUMMARY

An object of the present disclosure is to provide an impact rotary tool which may reduce the hitting sound.

An impact rotary tool according to an aspect of the present disclosure includes a motor, an output shaft to which a tip tool is attachable, an impact mechanism, an inner cover unit, and a body case. The impact mechanism is configured to apply impacting force to the output shaft in response to rotation of the motor. The body case houses the motor, the impact mechanism, and the inner cover unit. The impact mechanism includes a hammer member that hits, in response to the rotation of the motor, hit portion provided for the output shaft. The inner cover unit covers at least the impact mechanism.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is an exploded perspective view illustrating a main part of an impact rotary tool according to an embodiment of the present disclosure;

FIG. 2 is an exploded perspective view illustrating the impact rotary tool;

FIG. 3 is a side view illustrating the impact rotary tool;

FIG. 4 is a cross-sectional view taken along the plane A1-A2 of FIG. 3;

FIG. 5 is a cross-sectional view taken along the plane B1-B2 of FIG. 3;

FIG. 6 is an exploded perspective view illustrating a main part of an impact rotary tool according to a first variation of the exemplary embodiment in the present disclosure;

FIG. 7 is a perspective view illustrating the impact rotary tool according to the first variation;

FIG. 8 is a perspective view illustrating an inner cover unit of a screw fixing type included in an impact rotary tool according to a second variation;

FIG. 9 is a cross-sectional view illustrating the inner cover unit of the screw fixing type included in the impact rotary tool according to the second variation;

FIG. 10 is a perspective view illustrating an inner cover unit of a retaining ring fixing type included in an impact rotary tool according to the second variation;

FIG. 11 is a cross-sectional view illustrating the inner cover unit of the retaining ring fixing type included in the impact rotary tool according to the second variation;

FIG. 12 is a perspective view illustrating an inner cover unit of a threaded case fixing type included in an impact rotary tool according to the second variation;

FIG. 13 is a cross-sectional view illustrating the inner cover unit of the threaded case fixing type included in the impact rotary tool according to the second variation;

FIG. 14 is an exploded perspective view illustrating the inner cover unit of the threaded case fixing type included in the impact rotary tool according to the second variation;

FIG. 15 is a perspective view illustrating a hammer member included in an impact rotary tool according to a third variation; and

FIG. 16 is a cross-sectional view illustrating a main part of an impact rotary tool according to a fourth variation.

### DETAILED DESCRIPTION

An impact rotary tool according to an embodiment will now be described in detail with reference to the accompanying drawings. Note that the drawings to be referred to in the following description of embodiments are all schematic representations. Thus, the ratio of the dimensions of respective constituent elements illustrated on the drawings does not always reflect their actual dimensional ratio. Also, the configurations to be described in the embodiments below are only exemplary ones of various embodiments of the present disclosure and should not be construed as limiting. Rather, the exemplary embodiment may be readily modified in various manners depending on a design choice or any other factor without departing from the scope of the present disclosure.

### (Embodiment)

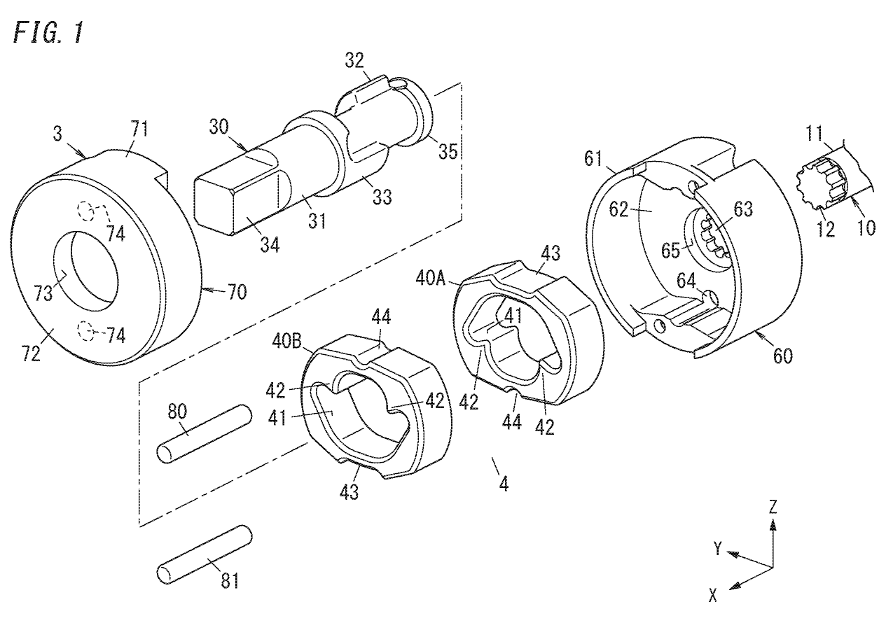

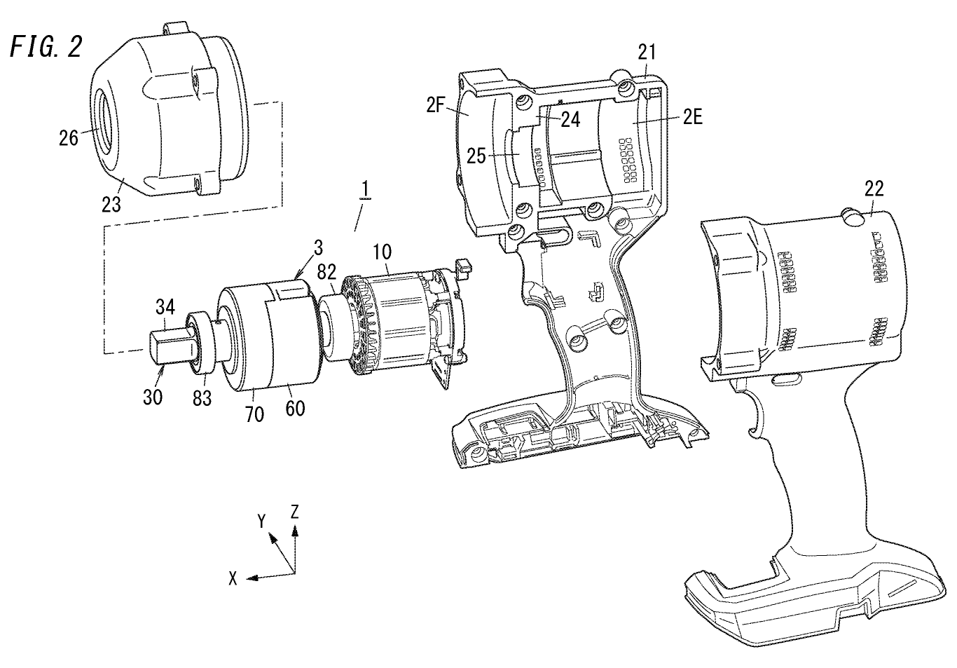

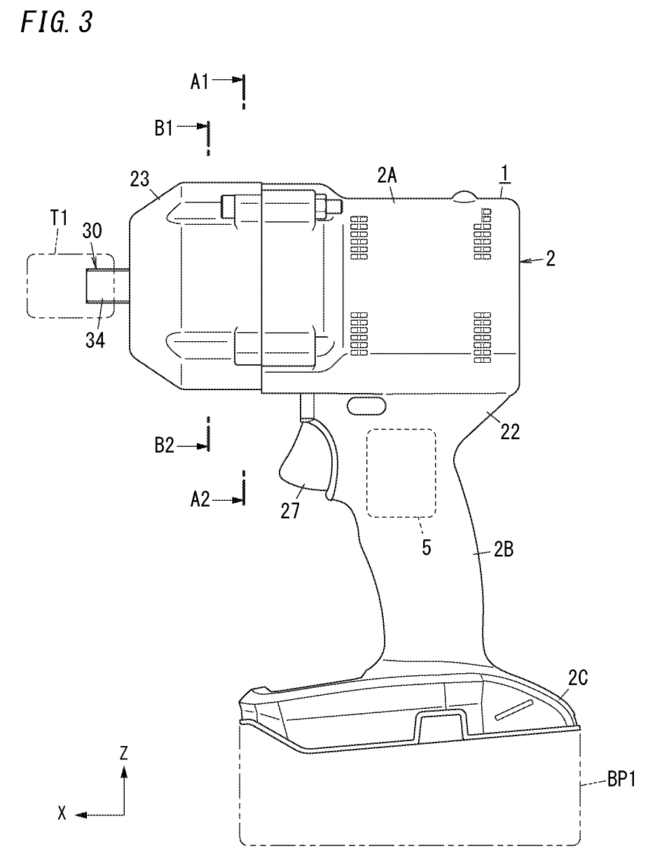

(1) Overview FIG. 1 is an exploded perspective view illustrating a main part of an impact rotary tool 1 according to this embodiment. FIG. 2 is an exploded perspective view illustrating the impact rotary tool 1. FIG. 3 is a side view illustrating the impact rotary tool 1.

The impact rotary tool 1 according to this embodiment includes a motor 10, an output shaft 30, an impact mechanism 4, an inner cover unit 3, and a body case 2.

A tip tool T1 is attachable to the output shaft 30.

The impact mechanism 4 applies impacting force to the output shaft 30 in response to the rotation of the motor 10.

The body case 2 houses the motor 10, the impact mechanism 4, and the inner cover unit 3.

The impact mechanism 4 includes hammer members 40A and 40B that hit, in response to the rotation of the motor 10, hit portions 32 and 33 provided for the output shaft 30.

The inner cover unit 3 covers at least the impact mechanism 4.

As used herein, the phrase “a tip tool T1 is attached to the output shaft 30” may refer to a situation where the tip tool T1 is attached directly to the output shaft 30 or a situation where the tip tool T1 is attached to the output shaft 30 via another member. Note that the tip tool T1 is not shown in FIG. 3 but the tip tool T1 is indicated by a long dashed double-short dashed line.

In the impact rotary tool 1 according to this embodiment, since the inner cover unit 3 housed in the body case 2 covers the impact mechanism 4, the impact mechanism 4 is double-covered by the inner cover unit 3 and the body case 2. This allows for reducing the hitting sound transmitted to the outside of the body case 2 if a hitting sound is generated when the hammer members 40A and 40B hit the hit portions 32 and 33. In addition, if the inner cover unit 3 is filled with a lubricant for helping the impact mechanism 4 to move smoothly, then the inner cover unit 3 allows for reducing the chances that the lubricant splashes. This makes it less easy for a lubricating effect of the lubricant to deteriorate. Thus, the impact rotary tool 1 according to this embodiment allows for reducing the chances of wear of members belonging to the impact mechanism 4. Also, the impact rotary tool 1 according to this embodiment does not include a speed reducing mechanism which decelerates the rotation of the rotary shaft 11 of the motor 10 and transmits the decelerated rotation to the output shaft 30. This achieves the advantage of reducing reaction force generated when the hammer members 40A and 40B hit the hit portions 32 and 33.

(2) Details

The impact rotary tool 1 according to this embodiment will now be described in detail with reference to FIGS. 1–5. In the following description, an X-axis direction (i.e., a direction in which the output shaft 30 protrudes from a body case 2) shown in FIG. 1 and other drawings will be referred to as a forward/backward direction, a Y-axis direction will be referred to as a rightward/leftward direction, and a Z-axis direction will be referred to as an upward/downward direction. Furthermore, the positive direction of the X-axis direction will be referred to as a front side, the positive direction of the Y-axis direction will be referred to as a right side, and the positive direction of the Z-axis direction will be referred to as an upper side. Note that these are exemplary directions and should not be construed as defining the direction when the impact rotary tool 1 is used. Also, arrows indicating respective directions in the drawings are only designated for the description and do not necessarily have substantive configurations.

(2.1) Configurations

The impact rotary tool 1 according to this embodiment is a portable electric tool. The impact rotary tool 1 is used, for example, for the operations of either tightening or loosening the fastening member such as a bolt or a screw.

The impact rotary tool 1 according to this embodiment includes, as described above, the motor 10, the output shaft 30, the impact mechanism 4, the inner cover unit 3, and the body case 2.

(2.1.1) Body Case

The body case 2 houses the motor 10, the output shaft 30, the impact mechanism 4, and the inner cover unit 3. Also, the body case 2 further houses a control circuit 5 and other members.

The body case 2 is formed by assembling a right case 21, a left case 22, and a front case 23. The body case 2 includes a housing portion 2A, a grip portion 2B, and an attached portion 2C with the right case 21, the left case 22, and the front case 23 assembled together.

The housing portion 2A has a hollow and cylindrical shape. A partition wall 24 divides the housing portion 2A in two rooms, namely a first housing room 2E in the rear side and a second housing room 2F in the front side. In the first housing room 2E, the motor 10 is housed, for example. In the second housing room 2F, the output shaft 30, the impact mechanism 4, and the inner cover unit 3 are housed, for example. In the partition wall 24, a recess portion 25 is provided. The recess portion 25 forms (a part of) a penetration hole through which the rotary shaft 11 of the motor 10 passes when the right case 21 and the left case 22 are assembled together. Also, in the front case 23, a round hole 26 is provided to allow a tip portion of the output shaft 30 to pass therethrough.

The grip portion 2B protrudes from the outer peripheral surface of the housing portion 2A toward one direction aligned with a radial direction of the housing portion 2A. The one direction is, for example, aligned with the upward/downward direction (refer to FIG. 3). The grip portion 2B is formed in a hollow and cylindrical shape having a longitudinal axis along the one direction. A worker may perform the operations such as tightening a screw by gripping the grip portion 2B. An operating member 27 is disposed on the grip portion 2B to accept an operating command entered by the worker.

The inner space of the grip portion 2B is connected to the inner space of the housing portion 2A. A first end of the longitudinal axis of the grip portion 2B is connected to the housing portion 2A, and a second end of the longitudinal axis of the grip portion 2B is connected to the attached portion 2C.

A battery pack BP1 is removably attached to the attached portion 2C. Note that the battery pack BP1 is not shown in FIG. 3 but the battery pack BP1 is indicated by a long dashed double-short dashed line. The impact rotary tool 1 is energized by the battery pack BP1. That is to say, the battery pack BP1 is a power supply supplying a current for driving the motor 10. The battery pack BP1 is not a constituent element of the impact rotary tool 1. The impact rotary tool 1 may, however, include the battery pack BP1.

(2.1.2) Motor

The motor 10 is housed in the housing portion 2A (more particularly, in the first housing room 2E) of the body case 2. The motor 10 is, for example, a brushless motor. The rotary shaft 11 of the motor 10 protrudes into the second housing room 2F through the recess portion 25. A pinion gear 12 is provided at the tip of the rotary shaft 11.

The torque and rotational speed of the motor 10 are controlled, for example, by the control circuit 5 (refer to FIG. 3). The control circuit 5 is housed, for example, in the grip portion 2B.

When a worker performs the operations using the impact rotary tool 1, he/she operates the operating member 27 disposed on the grip portion 2B. For example, the operating member 27 is a so-called “trigger switch” and he/she enters an operating command by pulling the operating member 27. The control circuit 5 determines a target value of the rotational speed of the motor 10 depending on how deep the operating member 27 is pulled. The deeper the operating member 27 is pulled, the greater the control circuit 5 sets the target value of the rotational speed of the motor 10. Note that a driving circuit for driving the motor 10 is housed inside the body case 2. The driving circuit causes the motor 10 to rotate at the rotational speed in accordance with the control signal received from the control circuit 5.

(2.1.3) Output Shaft

The output shaft 30 includes a shaft body 31 that is made of metallic material and that has the shape of a cylinder of which the central axis is aligned with the forward/backward direction, for example. A connecting portion 34 having the shape of a prism is provided at the front end of the shaft body 31. The connecting portion 34 of the output shaft 30 is exposed to the outside through the round hole 26 of the front case 23. The tip tool T1 is attached to the connecting portion 34 of the output shaft 30. The tip tool T1 is, for example, a screwdriver bit or a socket bit. The screwdriver bit and the socket bit are bits for use to either tighten or loosen the fastening member such as bolts. A tip tool T1 among various types of tip tools T1 is attached to the connecting portion 34 depending on an intended use. Note that a holder member for holding the tip tool T1 may be attached to the connecting portion 34. The tip tool T1 may also be attached to the connecting portion 34 via the holder member.

On the back part of the shaft body 31, the two hit portions 32 and 33 protruding in the opposite directions from each other along a radial direction are provided to be arranged in the forward/backward direction. Note that the hit portion 32 is positioned on the back side with respect to the hit portion 33. Each of the two hit portions 32 and 33 is formed to have the shape of a fan when viewed from the front.

(2.1.4) Impact Mechanism

The impact mechanism 4 is housed in the housing portion 2A (more particularly, in the second housing room 2F) of the body case 2. The impact mechanism 4 receives the rotational force from the motor 10, thereby hitting the hit portions 32 and 33 of the output shaft 30, thus causing the output shaft 30 to rotate.

The impact mechanism 4 includes the two hammer members 40A and 40B, two cam pins 80 and 81, and the inner cover unit 3 housing the two hammer members 40A and 40B. Also, the impact mechanism 4 further includes the hit portions 32 and 33 provided for the output shaft 30. The inner cover unit 3 is constituted by multiple members assembled together. The inner cover unit 3 has the shape of a circular cylinder overall. In this embodiment, the inner cover unit 3 is obtained by assembling the multiple members, namely, a first cylindrical body 60 and a second cylindrical body 70. The inner cover unit 3 constituted by the multiple members allows for making it easier to perform the operations to put the impact mechanism 4 inside the inner cover unit 3. Note that the first cylindrical body 60 is fixed and fastened to the second cylindrical body 70 with the fastening member such as a screw.

In addition, a lubricant (not shown) is filled inside the inner cover unit 3. That is to say, the impact rotary tool 1 further includes the lubricant filled inside the inner cover unit 3. The lubricant is, for example, lubricating grease for helping a machine to move smoothly and is filled in the contact areas between the hit portions 32 and 33 of the output shaft 30 and the hammer members 40A and 40B. Filling the contact areas between the hit portions 32 and 33 of the output shaft 30 and the hammer members 40A and 40B with the lubricant allows for reducing the chances of the occurrence of wear by the impact. Note that in the impact rotary tool 1 according to this embodiment, the inside of the inner cover unit 3 does not have to be filled by the lubricant but the lubricant may be omitted as appropriate.

The first cylindrical body 60 includes a circular cylindrical portion 61 having a circular cylindrical and hollow shape and a rear wall 62 having a circular plate shape which closes the rear end portion of the circular cylindrical portion 61. The first cylindrical body 60 is formed in the shape of a bottomed cylinder of which the rear end portion is closed. A recess portion 65 having the shape of a circle is provided in the center position of the front surface of the rear wall 62. A circular plate portion 35 at the rear end of the output shaft 30 is inserted into this recess portion 65. Also, a hole is provided in the bottom portion of the recess portion 65 in the rear wall 62. The pinion gear 12 provided as an integrated member with the rotary shaft 11 of the motor 10 is inserted into the hole. An internal gear 63 that engages with the pinion gear 12 is provided in the inner peripheral surface of the hole. With this configuration, the first cylindrical body 60 rotates as the rotary shaft 11 of the motor 10 rotates. That is to say, the inner cover unit 3 rotates in response to the rotation of the rotary shaft 11 of the motor 10. Energy generated by the impact can be converted into inertial energy by the rotation of the inner cover unit 3. This allows for increasing the output torque. Also, in the rear wall 62, two holding holes 64, into which the respective rear end portions of the two cam pins 80 and 81 are inserted, are respectively provided in positions symmetrical with respect to the center of the circular cylindrical portion 61. The two cam pins 80 and 81 are round bars which are made of metal and have the same diameter and total length.

The second cylindrical body 70 includes a circular cylindrical portion 71 having a circular cylindrical and hollow shape and a front wall 72 having a circular plate shape which closes the front end portion of the circular cylindrical portion 71. The second cylindrical body 70 is formed in the shape of a bottomed cylinder of which the front end portion is closed. A round hole 73 through which the output shaft 30 passes is provided in the center of the front wall 72. In the back surface of the front wall 72, two holding holes 74, into which the respective front ends of the two cam pins 80 and 81 are inserted, are respectively provided in positions facing the two holding holes 64 provided in the rear wall 62 of the first cylindrical body 60. The two holding holes 74 are respectively provided in positions symmetrical with respect to the center of the circular cylindrical portion 71.

The two hammer members 40A and 40B have the same shape, and therefore, description of the hammer member 40B will be omitted herein as appropriate by describing the shape of the hammer member 40A as an example. The hammer members 40A and 40B are arranged in the forward/backward direction and the hammer member 40A is positioned behind the hammer member 40B.

The hammer member 40A is formed in the shape of an oval when viewed from the front. An insertion hole 41, into which the hit portion 32 of the output shaft 30 is inserted, is provided in the center of the hammer member 40A. The hammer member 40A has the shape of a hollow cylinder and is provided with the insertion hole 41 into which the output shaft 30 is inserted. Note that the hit portion 33 of the output shaft 30 is inserted into an insertion hole 41 of the hammer member 40B.

A first groove 43 into which the cam pin 80 is inserted and a second groove 44 into which the cam pin 81 is inserted are provided on the outer peripheral surface of the hammer member 40A to face each other with the insertion hole 41 interposed therebetween. In a similar manner, a first groove 43 into which the cam pin 81 is inserted and a second groove 44 into which the cam pin 80 is inserted are provided on the outer peripheral surface of the hammer member 40B to face each other with the insertion hole 41 interposed therebetween. Hereinafter, a cam pin inserted into the first groove 43 of the hammer member 40A, 40B (the cam pin 80 for the hammer member 40A and the cam pin 81 for the hammer member 40B ) will also be referred to as a “first cam pin”, and a cam pin inserted into the second groove 44 of the hammer member 40A, 40B (the cam pin 81 for the hammer member 40A and the cam pin 80 for the hammer member 40B ) will also be referred to as a “second cam pin. That is to say, the first groove 43 and the second groove 44, into which the cam pin 80 (serving as the first cam pin) and the cam pin 81 (serving as the second cam pin) fixed to the inner cover unit 3 are respectively inserted, are provided for the hammer member 40A. Also, the first groove 43 and the second groove 44, into which the cam pin 81 (serving as the first cam pin) and the cam pin 80 (serving as the second cam pin) fixed to the inner cover unit 3 are respectively inserted, are provided for the hammer member 40B. The first groove 43 is formed to have a width larger than the diameter of the first cam pin. The second groove 44 is formed to have a groove width as large as the diameter of the second cam pin. In addition, two hitting portions 42 are provided on the inner surface of the insertion hole 41 at positions closer to the second groove 44 than the first groove 43 with the second groove 44 interposed therebetween. The two hitting portions 42 are provided to protrude inward from the inner surface of the insertion hole 41.

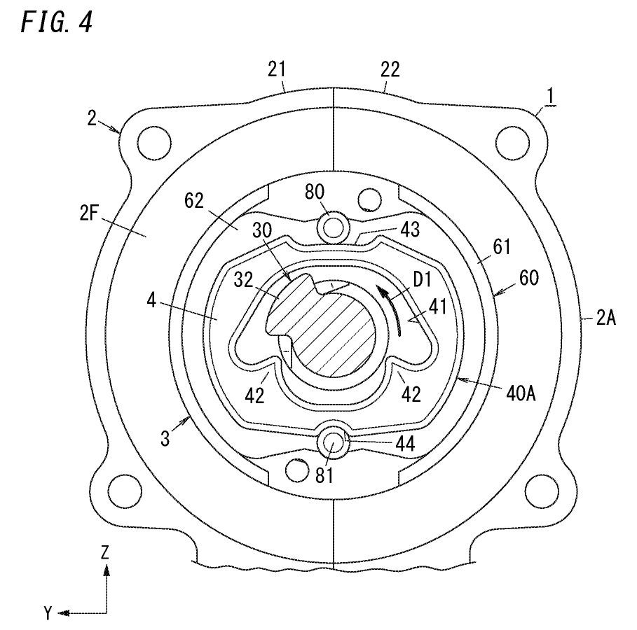

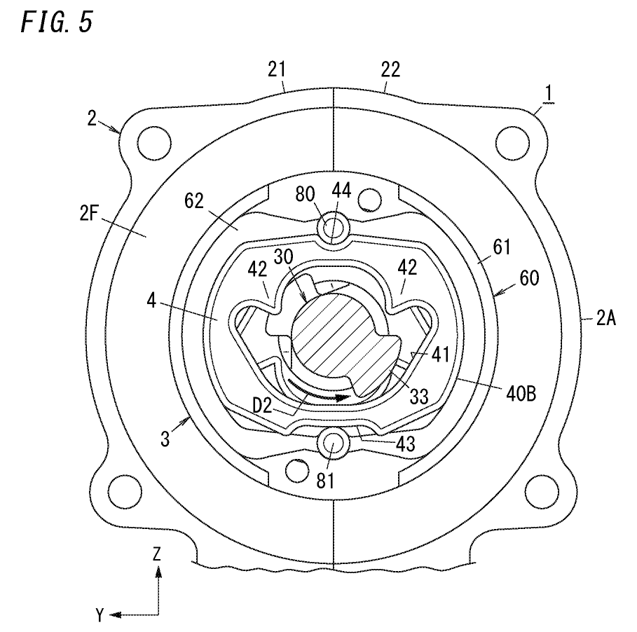

As shown in FIG. 4, the hammer member 40A is housed inside the inner cover unit 3 in such a manner that the cam pin 80 (serving as the first cam pin) is inserted into the first groove 43 and the cam pin 81 (serving as the second cam pin) is inserted into the second groove 44. On the other hand, as shown in FIG. 5, the hammer member 40B is housed inside the inner cover unit 3 in such a manner that the cam pin 81 (serving as the first cam pin) is inserted into the first groove 43 of the hammer member 40B and the cam pin 80 (serving as the second cam pin) is inserted into the second groove 44 of the hammer member 40B. That is to say, the hammer member 40A and the hammer member 40B are housed in the inner cover unit 3 in such a manner that the hammer member 40A and the hammer member 40B are inverted from each other in a direction in which the two cam pins 80 and 81 are arranged.

(2.2) Description of How to Assemble

As can be seen from the foregoing description, the motor 10, the output shaft 30, the impact mechanism 4, the inner cover unit 3, the control circuit 5, and other members are housed inside the body case 2 of the impact rotary tool 1.

In this embodiment, the impact mechanism 4 and the inner cover unit 3 are assembled in the following process. Note that the assembling procedure to be described below is only an example and should not be construed as limiting. Rather, some process steps of this procedure may be performed in a different order from the one to be described below.

For example, an assembling worker inserts the respective rear end portions of the two cam pins 80 and 81 into the two holding holes 64 provided in the rear wall 62 of the first circular cylindrical body 60 that belongs to the inner cover unit 3. Then, the assembling worker inserts the hammer member 40A into the first cylindrical body 60 such that the cam pin 80 (serving as the first cam pin) is inserted into the first groove 43 and the cam pin 81 (serving as the second cam pin) is inserted into the second groove 44 (refer to FIG. 4). Also, the assembling worker inserts the hammer member 40B into the first cylindrical body 60 such that the cam pin 80 (serving as the second cam pin) is inserted into the second groove 44 and the cam pin 81 (serving as the first cam pin) is inserted into the first groove 43. The assembling worker inserts the output shaft 30 into the first cylindrical body 60 such that the hit portion 32 in the rear part of the output shaft 30 is inserted into the insertion hole 41 of the hammer member 40A on the back side and the hit portion 33 in the front part of the output shaft 30 is inserted into the insertion hole 41 of the hammer member 40B on the front side. In this step, the circular plate portion 35 at the rear end of the output shaft 30 is inserted in the recess portion 65 in the rear wall 62 of the first cylindrical body 60. Then, the assembling worker fills the inside of the first circular cylindrical body 60 with the lubricant, and then attaches the second cylindrical body 70 on the front side of the first circular cylindrical body 60 such that the respective front end portions of the cam pins 80 and 81 are inserted into the two holding holes 74 of the second cylindrical body 70. Thereafter, the assembling worker performs a work to fix and fasten the first cylindrical body 60 and the second cylindrical body 70 with the fastening member such as a screw or a bolt. With the first cylindrical body 60 and the second cylindrical body 70 assembled to form the inner cover unit 3, the front end portion of the output shaft 30 protrudes forward from the round hole 73 of the second cylindrical body 70.

Next, the assembling worker inserts the motor 10 into the first housing room 2E of the right case 21 and also inserts the inner cover unit 3 that has housed the impact mechanism 4 and the output shaft 30 into the second housing room 2F of the right case 21 with the pinion gear 12 of the rotary shaft 11 of the motor 10 inserted into the internal gear 63 of the first cylindrical body 60. Also, after disposing the control circuit 5, the operating member 27, and other members in the grip portion 2B of the right case 21, the assembling worker puts the left case 22 over the right case 21, and fastens the right case 21 and the left case 22 together with the fastening member such as a screw or a bolt. Then, the assembling worker attaches the front case 23 to the assemblage of the right case 21 and the left case 22 to close the opening which is formed at the front end portion of the assemblage of the right case 21 and the left case 22 and then fastens the right case 21, the left case 22, and the front case 23 together with the fastening member such as a screw or a bolt. In this case, the tip of the output shaft 30 protrudes forward from the round hole 26 of the front case 23. Note that a bearing 82 (refer to FIG. 2) is attached to the rotary shaft 11 of the motor 10. The rotary shaft 11 of the motor 10 is supported by the right case 21 and the left case 22 via the bearing 82 in the state that the rotary shaft 11 of the motor 10 is ready to rotate. Also, a bearing 83 (refer to FIG. 2) is attached to the output shaft 30. The output shaft 30 is supported by the front case 23 via the bearing 83 in the state that the output shaft 30 is ready to rotate.

The impact rotary tool 1 can be assembled through the procedure described above. After that, when the battery pack BP1 is attached to the attached portion 2C, the battery pack BP1 is ready to supply electric power to the control circuit 5 and other members. Therefore, the worker can perform the operations using the impact rotary tool 1.

(2.3) Description of operations

When the worker, who performs the fastening operations using the impact rotary tool 1, pulls the operating member 27 of the impact rotary tool 1, the control circuit 5 determines a target value of the rotational speed of the motor 10 according to how deep the operating member 27 is pulled, and then outputs a control signal to the driving circuit. The driving circuit controls the electric power to be supplied to the motor 10 in accordance with the control signal output by the control circuit 5, thus causing the motor 10 to rotate. In a particular setting where the rotary shaft 11 of the motor 10 rotates counterclockwise when viewed from the front, the inner cover unit 3 rotates counterclockwise when viewed from the front because the pinion gear 12 at the tip of the rotary shaft 11 engages with the internal gear 63 of the inner cover unit 3. The cam pins 80 and 81 attached to the inner cover unit 3 are inserted into the first groove 43 and second groove 44 of the hammer members 40A and 40B, thus the hammer members 40A and 40B rotate together with the inner cover unit 3 as the inner cover unit 3 rotates.

In this case, when the hammer member 40A rotates counterclockwise (as indicated by the arrow D1 shown in FIG. 4) from the current position shown in FIG. 4 in response to the rotation of the inner cover unit 3, the hitting portion 42 on the right side of the hammer member 40A strikes against the hit portion 32 of the output shaft 30. The hammer member 40A is ready to swing around the cam pin 81 (serving as the second cam pin) inserted into the second groove 44 within the range that the cam pin 80 (serving as the first cam pin) is allowed to move within the first groove 43. Therefore, the hammer member 40A swings around the cam pin 81, which is inserted into the second groove 44, in one direction until the cam pin 80 reaches one end of the first groove 43. Thereafter, when the hammer member 40A further rotates counterclockwise in response to the rotation of the inner cover unit 3, the hitting portion 42 climbs over the hit portion 32 and then the inner peripheral surface of the insertion hole 41 is pushed by the hit portion 32, thus the hammer member 40A swings around the cam pin 81, which is inserted into the second groove 44, in another direction opposite from the one direction described above.

Note that the hit portion 33 of the output shaft 30 protrudes in the opposite direction from the hit portion 32 and the hammer member 40B is disposed upside-down with respect to the hammer member 40A. Therefore, when the hammer member 40B rotates counterclockwise (as indicated by the arrow D2 shown in FIG. 5) from the current position shown in FIG. 5 in response to the rotation of the inner cover unit 3, the hitting portion 42 on the left side of the hammer member 40B strikes against the hit portion 33 at the same time at which the hitting portion 42 on the right side of the hammer member 40A strikes against the hit portion 32. In this case, the hammer member 40B is ready to swing around the cam pin 80 (serving as the second cam pin) inserted into the second groove 44 within the range that the cam pin 81 (serving as the first cam pin) is allowed to move within the first groove 43. Therefore, the hammer member 40B swings around the cam pin 80, which is inserted into the second groove 44, in one direction until the cam pin 81 reaches one end of the first groove 43. Thereafter, when the hammer member 40B further rotates counterclockwise in response to the rotation of the inner cover unit 3, the hitting portion 42 climbs over the hit portion 33 and then the inner peripheral surface of the insertion hole 41 is pushed by the hit portion 33, thus the hammer member 40B swings around the cam pin 80, which is inserted into the second groove 44, in another direction opposite from the one direction described above.

As described above, when the inner cover unit 3 rotates in response to the rotation of the rotary shaft 11 of the motor 10, the hitting portion 42 of the hammer member 40A and the hitting portion 42 of the hammer member 40B respectively hit the hit portions 32 and 33 of the output shaft 30 in response to the rotation of the inner cover unit 3. As a result, the output shaft 30 rotates. Thus, the output shaft 30 rotates by being energized by the impacting force applied from the impact mechanism 4. This allows for providing the impact rotary tool 1 with high torque, thus the operations such as tightening or loosening the fastening member is performed by using the tip tool T1 held by the output shaft 30.

Note that in another setting where the rotary shaft 11 of the motor 10 rotates clockwise when viewed from the front, then the hit portions 32 and 33 are hit by the other hitting portions 42 of the hammer members 40A and 40B as opposed to the ones that hit the hit portions 32 and 33 in the setting described above where the rotary shaft 11 rotates counterclockwise when viewed from the front, which also allowing the output shaft 30 to rotate by the impact.

In this embodiment, the two hit portions 32 and 33 are respectively provided on the output shaft 30 of the impact rotary tool 1 in positions symmetrical with respect to the rotational axis of the output shaft 30. The impact mechanism 4 includes the two hammer members 40A and 40B correspond one to one to the two hit portions 32 and 33. Each of the two hammer members 40A and 40B hits the corresponding one of two hit portions 32 and 33 in response to the rotation of the motor 10. The two hammer members 40A and 40B hit the two hit portions 32 and 33 of the output shaft 30, which allows for applying the impacting force equally to the two hit portions 32 and 33 provided respectively in positions symmetrical with respect to the rotational axis of the output shaft 30. Therefore, the two hammer members 40A and 40B hit the two hit portions 32 and 33 of the output shaft 30, which enables the output shaft 30 to rotate smoothly.

Also, the two hitting portions 42 of the two hammer members 40A and 40B hit the hit portions 32 and 33, which protrude from the center of the output shaft 30 in the opposite directions from each other, at the same time, thus the impacting force is transmitted to the output shaft 30 evenly. This allows the output shaft 30 to rotate smoothly. Note that “the time at which the hitting portion 42 of the hammer member 40A hits the hit portion 32 and the time at which the hitting portion 42 of the hammer member 40B hits the hit portion 33 are the same time” is not limited to perfectly the same time. Alternatively, the time gap between the time at which the hitting portion 42 of the hammer member 40A hits the hit portion 32 and the time at which the hitting portion 42 of the hammer member 40B hits the hit portion 33 only needs to be at most equal to or less than 10 percent of the period of one cycle of the inner cover unit 3.

(3) Variations

Note that the embodiment described above is only an exemplary one of various embodiments of the present disclosure and should not be construed as limiting. Rather, the exemplary embodiment described above may be readily modified in various manners depending on a design choice or any other factor without departing from the scope of the present disclosure.

Next, variations of the exemplary embodiment will be enumerated one after another. Note that the variations to be described below may be adopted in combination as appropriate. Note that in the following description, the embodiment described above will be referred to as a basic configuration.

(3.1) First Variation

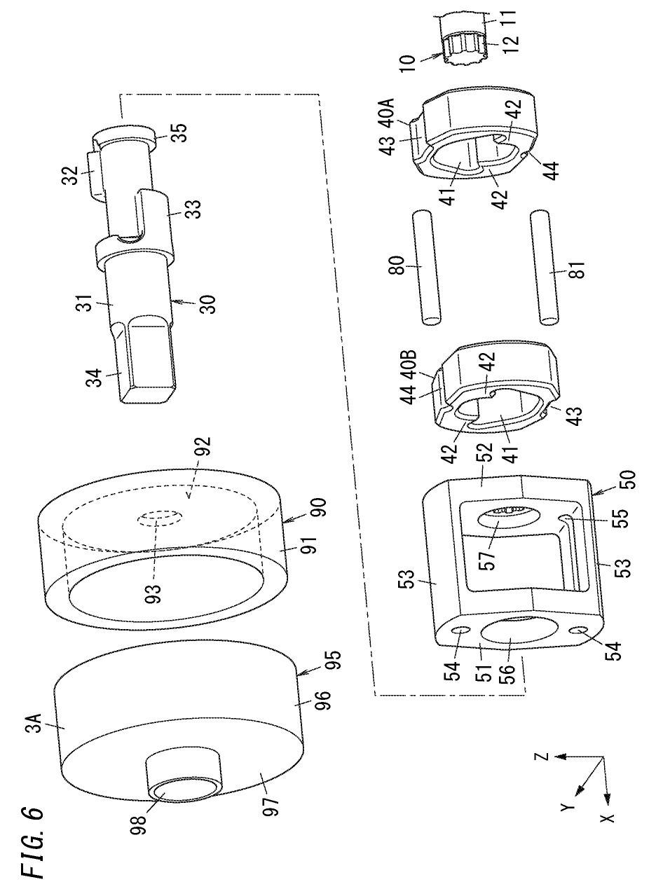

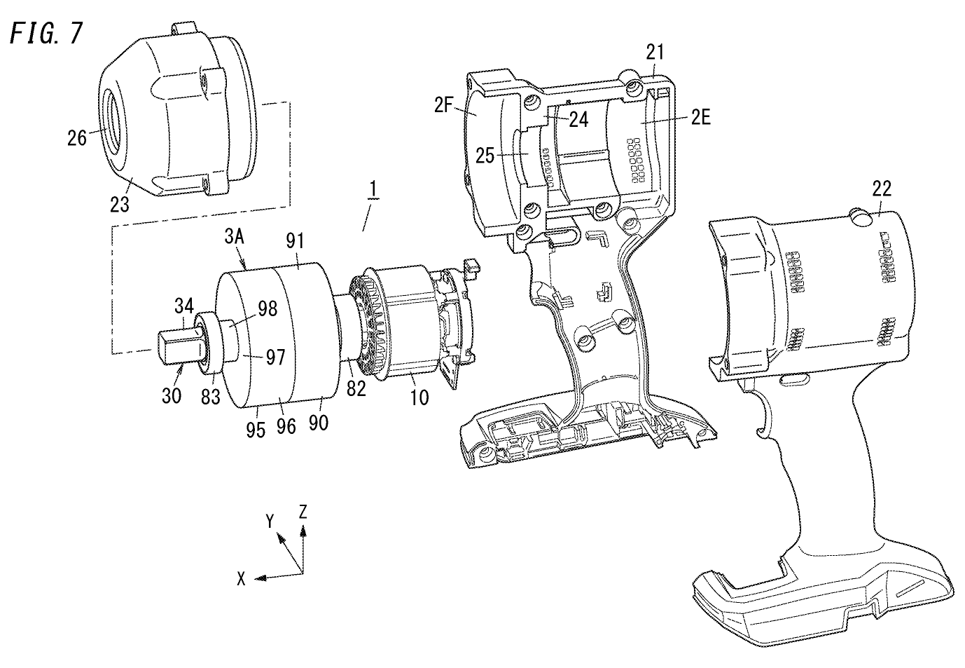

An impact rotary tool 1 according to a first variation of this embodiment will be described with reference to FIGS. 6 and 7. In the impact rotary tool 1 according to the first variation, an inner cover unit 3A is fixed to a body case 2, which is a difference from the impact rotary tool 1 according to the basic configuration. Note that constituent elements of the impact rotary tool 1 according to the first variation having the same feature as the basic configuration will be designated by the same reference sign and description thereof will be omitted herein to avoid redundancy.

Contrary to the basic configuration where the inner cover unit 3 serves as the cam case holding the hammer members 40A and 40B, the impact rotary tool 1 according to the first variation includes a cam case 50, which is different from the inner cover unit 3A, holding the hammer members 40A and 40B. In the impact rotary tool 1 according to the first variation, the inner cover unit 3A covers the hammer members 40A and 40B, the cam case 50, and hit portions 32 and 33 of the output shaft 30. The inner cover unit 3A and the cam case 50 are different members from each other.

The cam case 50 is formed to have a frame shape with a pair of first plate pieces 51 and 52 facing each other in a direction aligned with the axis of the output shaft 30 and a pair of second plate pieces 53 and 53 for joining end portions of the pair of first plate pieces 51 and 52.

Each of the pair of first plate pieces 51 and 52 has the shape of a rectangular plate.

A penetration hole 56, into which the output shaft 30 is inserted, is provided in the middle portion of a longitudinal axis of the first plate piece 51. Also, two penetration holes 54 are provided for the first plate piece 51 in positions symmetrical with respect to the center of the penetration hole 56. Respective first ends (i.e., the respective front end portions) of longitudinal axes of two cam pins 80 and 81 are inserted into the two penetration holes 54 of the first plate piece 51.

A penetration hole 57, into which the output shaft 30 is inserted, is provided in the middle portion of a longitudinal axis of the first plate piece 52. Also, two penetration holes 55 are provided for the first plate piece 52 in positions symmetrical with respect to the center of the penetration hole 57. Respective second ends (i.e., the respective rear end portions) of the longitudinal axes of the two cam pins 80 and 81 are inserted into the two penetration holes 55 of the first plate piece 52.

In the cam case 50, the cam pins 80 and 81 are inserted into the penetration holes 54 and 55 of the first plate pieces 51 and 52 with the two hammer members 40A and 40B inserted into the space between the pair of first plate pieces 51 and 52. In this case, the cam pin 80 is inserted into a first groove 43 of the hammer member 40A and a second groove 44 of the hammer member 40B. The cam pin 81 is inserted into a second groove 44 of the hammer member 40A and a first groove 43 of the hammer member 40B. As a result, the hammer member 40A is supported by the cam case 50 in the state that the hammer member 40A is allowed to swing around the cam pin 81 (serving as the second cam pin) inserted into the second groove 44. Also, the hammer member 40B is supported by the cam case 50 in the state that the hammer member 40B is allowed to swing around the cam pin 80 (serving as the second cam pin) inserted into the second groove 44.

A pinion gear 12 is provided for the rotary shaft 11 of the motor 10, and an internal gear that engages with the pinion gear 12 is provided for the rear portion of the penetration hole 57 of the first plate piece 52. As the rotary shaft 11 of the motor 10 rotates, the cam case 50 rotates together with the rotary shaft 11. In response to the rotation of the cam case 50, the hitting portion 42 of the hammer member 40A hits the hit portion 32 of the output shaft 30, and the hitting portion 42 of the hammer member 40B hits the hit portion 33 of the output shaft 30. As a result, the output shaft 30 rotates by being energized by the impacting force applied to the output shaft 30. Note that the operation in which the hammer members 40A and 40B hit the output shaft 30 is the same as in the basic configuration, and therefore, description thereof will be omitted herein to avoid redundancy.

The impact rotary tool 1 according to the first variation includes the cam case 50 for holding the hammer members 40A and 40B. That is to say, the impact mechanism 4 includes the hammer members 40A and 40B, the cam case 50, the cam pins 80 and 81, and the hit portions 32 and 33 of the output shaft 30.

The inner cover unit 3A is a combination of a first cylindrical body 90 in the rear part and a second cylindrical body 95 in the front part. The first cylindrical body 90 is fixed and fastened to the second cylindrical body 95 with the fastening member such as a screw. A lubricant (not shown) is filled inside the inner cover unit 3A. The lubricant is, for example, lubricating grease for helping a machine to move smoothly and is filled in the contact areas between the hit portions 32 and 33 of the output shaft 30 and the hammer members 40A and 40B. Filling the contact areas between the hit portions 32 and 33 of the output shaft 30 and the hammer members 40A and 40B with the lubricant allows for reducing the chances of the occurrence of wear by the impact.

The first cylindrical body 90 includes a circular cylindrical portion 91 having a hollow and circular cylindrical shape and a rear wall 92 having a circular plate shape which closes the rear end portion of the circular cylindrical portion 91. The first cylindrical body 90 is formed in the shape of a bottomed cylinder of which the rear end portion is closed. A penetration hole 93 into which the rotary shaft 11 of the motor 10 is inserted is provided in the center position of the rear wall 92.

The second cylindrical body 95 includes a circular cylindrical portion 96 having a hollow and circular cylindrical shape and a front wall 97 having a circular plate shape which closes the front end portion of the circular cylindrical portion 96. The second cylindrical body 95 is formed in the shape of a bottomed cylinder of which the front end portion is closed. A round hole 98 through which the output shaft 30 passes is provided in the center of the front wall 97.

The inner cover unit 3A, which houses the hammer members 40A and 40B, the cam case 50, the cam pins 80 and 81, and the hit portions 32 and 33 provided for the output shaft 30, is fixed to the body case 2 by a method as appropriate. That is to say, the inner cover unit 3A is fixed to the body case 2 and does not rotate in response to the rotation of the rotary shaft 11 of the motor 10. This can reduce the load applied to the motor 10 compared with a situation where the inner cover unit 3 rotates in response to the rotation of the rotary shaft 11 of the motor 10. Note that the cam case 50 is housed inside the inner cover unit 3A in the state of being ready to rotate and rotates in response to the rotation of the rotary shaft 11 of the motor 10.

The impact mechanism 4 is covered with the inner cover unit 3A also in the impact rotary tool 1 according to the first variation, which allows for reducing the hitting sound transmitted to the outside of the body case 2 if a hitting sound is generated when the hammer members 40A and 40B hit the hit portions 32 and 33. In addition, the inner cover unit 3A allows for reducing the chances that the lubricant, which is filled in the inner cover unit 3A for helping the impact mechanism 4 to move smoothly, splashes. This makes it less easy for a lubricating effect of the lubricant to deteriorate. Thus, the impact rotary tool 1 according to the first variation allows for reducing the chances of wear of members belonging to the impact mechanism 4.

Note that in the impact rotary tool 1 according to the first variation, the inner cover unit 3A is fixed to the body case 2, which can reduce the load applied to the motor 10 compared with a situation where the inner cover unit 3A rotates in response to the rotation of the rotary shaft 11 of the motor 10.

(3.2) Second Variation

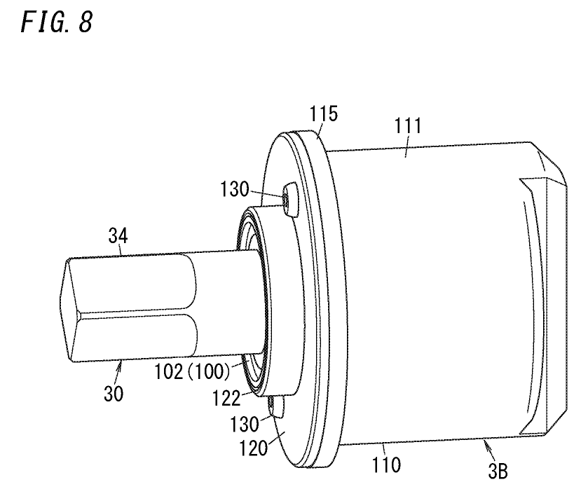

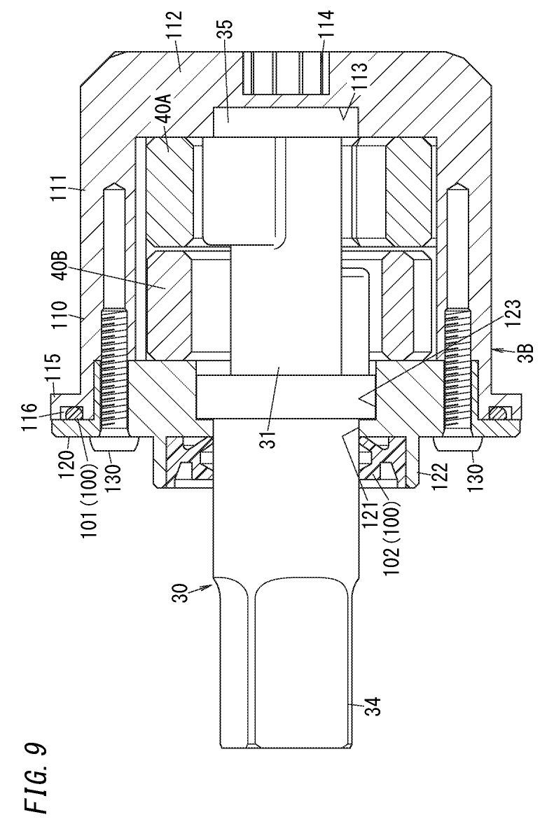

An impact rotary tool 1 according to a second variation will be described with reference to FIGS. 8 and 9. The impact rotary tool 1 according to the second variation further includes a sealing member 100 for sealing an inner cover unit 3B, which is a difference from the impact rotary tool 1 according to the basic configuration. Note that the impact rotary tool 1 according to the second variation includes the same configuration as the basic configuration except that the inner cover unit 3B includes the sealing member 100, and therefore, constituent elements of the impact rotary tool 1 according to the second variation having the same feature as the basic configuration will be designated by the same reference sign and description thereof will be omitted herein to avoid redundancy.

As used in the present disclosure, the phrase “seal” the inner cover unit 3B is not limited to seal the inner cover unit 3B in a strict sense of a word. Alternatively, the phrase “seal” the inner cover unit 3B may also refer to at least partially close gaps in the inner cover unit 3B so that the inner cover unit 3B has smaller gaps.

The inner cover unit 3B included in the impact rotary tool 1 according to the second variation is obtained by assembling a cylindrical body 110 and a lid member 120. The cylindrical body 110 and the lid member 120 are, for example, made of metallic material.

The cylindrical body 110 includes a circular cylindrical portion 111 having a hollow and circular cylindrical shape and a rear wall 112 which closes the rear end portion of the circular cylindrical portion 111. The cylindrical body 110 is formed in the shape of a bottomed cylinder of which the rear end portion is closed. A recess portion 113 having the shape of a round hole is provided in the center position of the front surface of the of the rear wall 112. A circular plate portion 35, which is the rear end of an output shaft 30, is inserted into this recess portion 113. In the front surface of the rear wall 112, two holding holes (not shown), into which the respective rear end portions of the cam pins 80 and 81 (not shown) are inserted, are provided as in the first cylindrical body 60 according to the basic configuration.

An internal gear 114 that engages with a pinion gear 12, which is provided as an integrated member with a rotary shaft 11 of a motor 10, is provided in the center position of the rear surface of the rear wall 112. As a result, when the rotary shaft 11 of the motor 10 rotates, the cylindrical body 110 rotates together. That is to say, the inner cover unit 3B rotates in response to the rotation of the rotary shaft 11 of the motor 10.

A flange portion 115 having the shape of a ring and protruding outward in a radial direction is provided in the front end portion of the circular cylindrical portion 111. A recess groove 116, into which an O-ring 101 serving as the sealing member 100 is inserted, is provided in the front surface of the flange portion 115.

The lid member 120 is formed to have a disk shape. A round hole 121 to allow a shaft body 31 of the output shaft 30 to pass therethrough is provided in the center position of the lid member 120. On the front surface of the lid member 120, a rib 122 having the shape of a circular cylinder is provided around the round hole 121. An oil seal 102, which serves as the sealing member 100, is disposed inside the rib 122 to close the gap between the output shaft 30 and the lid member 120 that perform rotational movements. A large-diameter hole 123 having a diameter larger than a diameter of the round hole 121 is provided in the rear surface of the lid member 120. The shaft body 31 of the output shaft 30 is inserted inside the large-diameter hole 123.

The cylindrical body 110 and the lid member 120 are fastened with, for example, two screws 130. When assembling the inner cover unit 3B, first, an assembling worker puts the cam pins 80 and 81, hammer members 40A and 40B, and the output shaft 30 inside the cylindrical body 110, and then fills the cylindrical body 110 with a lubricant and inserts the O-ring 101 into the recess groove 116 of the cylindrical body 110. Next, the assembling worker inserts the shaft body 31 of the output shaft 30 into the large-diameter hole 123 of the lid member 120, puts the rear surface of the lid member 120 over the flange portion 115 of the cylindrical body 110 and joins the cylindrical body 110 and the lid member 120 with the two screws 130. In this case, the tip portion of the output shaft 30 protrudes forward from the round hole 121 of the lid member 120. The oil seal 102 attached inside the rib 122 of the lid member 120 is brought into contact with the peripheral surface of the shaft body 31 of the output shaft 30. In this manner, the assembling worker finishes assembling the inner cover unit 3B and inserts the inner cover unit 3B thus assembled into the second housing room 2F of either right case 21 or left case 22.

In the state that the inner cover unit 3B is assembled, the gap between the flange portion 115 of the cylindrical body 110 and the lid member 120 is closed with the O-ring 101. Also, in an area where the shaft body 31 is inserted into the large-diameter hole 123 of the lid member 120, the gap between the lid member 120 and the shaft body 31 has a cranked shape when viewed from the direction intersecting at the right angle with the diameter of the shaft body 31. This allows for reducing the chances that the lubricant leaks out of the gap between the lid member 120 and the shaft body 31 compared with a situation where the gap between the lid member 120 and the shaft body 31 is straight. Also, the oil seal 102 attached inside the rib 122 is brought into contact with the surface of the shaft body 31 of the output shaft 30, which further reduces the chances that the lubricant leaks out of the gap between the lid member 120 and the shaft body 31. Therefore, the impact rotary tool 1 according to the second variation reduces the chances that the lubricant filled in the inner cover unit 3B leaks out of the inner cover unit 3B. This allows for further reducing the chances that a lubricating effect of the lubricant deteriorates. In the inner cover unit 3B shown in FIGS. 8 and 9, the sealing member 100 is constituted by the O-ring 101 and the oil seal 102.

Note that, in the inner cover unit 3B shown in FIGS. 8 and 9, the method for joining the cylindrical body 110 and the lid member 120 is a screw fixing method using the screws 130. However, the method for joining the cylindrical body 110 and the lid member 120 is not limited to the method described above.

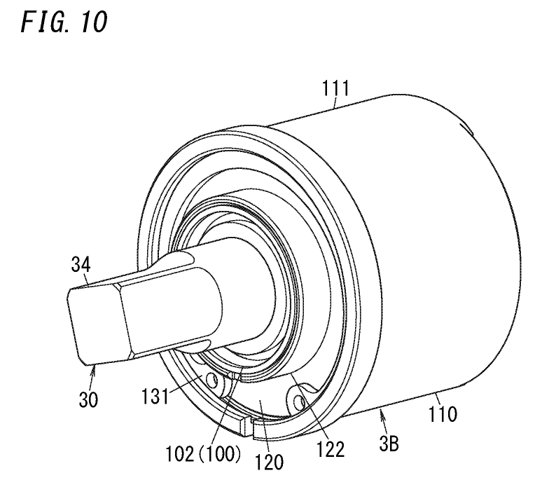

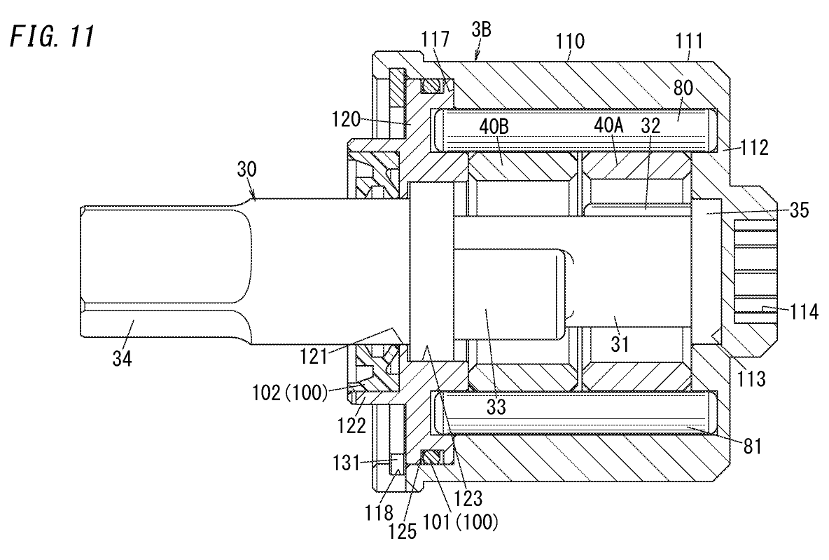

For example, the cylindrical body 110 and the lid member 120 may be joined together by a retaining ring fixing method using a retaining ring 131 as shown in FIGS. 10 and 11. The inner cover unit 3B shown in FIGS. 10 and 11 includes the same configuration as the inner cover unit 3B shown in FIGS. 8 and 9 except that the cylindrical body 110 and the lid member 120 are joined to each other using the retaining ring 131, and therefore, constituent elements having the same feature will be designated by the same reference sign and description thereof will be omitted herein to avoid redundancy.

In the inner cover unit 3B shown in FIGS. 10 and 11, a step portion 117, which is brought into contact with a part of the rear surface of the lid member 120, is provided on the inner surface of the circular cylindrical portion 111 of the cylindrical body 110. Also, a recess groove 118 in which the retaining ring 131 fits is provided in the inner surface of the circular cylindrical portion 111 of the cylindrical body 110. The recess groove 118 is provided at a position in front of the step portion 117 and extends along the circumference direction.

The lid member 120 is formed to have a disk shape. The external dimension of the lid member 120 is slightly smaller than the inner diameter dimension of the opening of the cylindrical body 110. The lid member 120 is inserted inside the cylindrical body 110. A part of the rear surface of the lid member 120 is brought into contact with the step portion 117, as a result, the lid member 120 is positionally fixed such that the lid member 120 is not allowed to move backward anymore. Also, in the state that the part of the rear surface of the lid member 120 inserted into the cylindrical body 110 is brought into contact with the step portion 117, the front surface of the lid member 120 is positioned slightly behind a recess groove 118 of the cylindrical body 110.

The lid member 120 is formed to have a disk shape. A round hole 121 that allows the shaft body 31 of the output shaft 30 to pass therethrough is provided in the center position of the lid member 120. In the front surface of the lid member 120, a rib 122 having the shape of a circular cylinder is provided around the round hole 121. The oil seal 102, which serves as the sealing member 100, is disposed inside the rib 122 to close the gap between the output shaft 30 and the lid member 120 that perform rotational movements. The large-diameter hole 123 having a diameter larger than a diameter of the round hole 121 is provided in the rear surface of the lid member 120. The shaft body 31 of the output shaft 30 is inserted inside the large-diameter hole 123. Also, in the side surface of the lid member 120 (i.e., a surface facing the inner surface of the circular cylindrical portion 111), a recess groove 125 into which the O-ring 101 serving as the sealing member 100 is inserted is provided along the entire circumference of the lid member 120.

When assembling the inner cover unit 3B, first, an assembling worker puts the cam pins 80 and 81, the hammer members 40A and 40B, and the output shaft 30 inside the cylindrical body 110, and then fills the cylindrical body 110 with a lubricant. Next, the assembling worker inserts the lid member 120, of which the recess groove 125 is fit with the O-ring 101, into the cylindrical body 110. Then, the shaft body 31 of the output shaft 30 is inserted into the large-diameter hole 123 of the lid member 120, and the tip portion of the shaft body 31 protrudes forward from the round hole 121. In this step, a part of the rear surface of the lid member 120 is brought into contact with the step portion 117, thus the lid member 120 is not allowed to move backward anymore. Thereafter, the assembling worker fits the retaining ring 131 to the recess groove 118 of the cylindrical body 110, thus the lid member 120 is held between the retaining ring 131 and the step portion 117. Therefore, the cylindrical body 110 and the lid member 120 are joined together. As a result, the opening of the cylindrical body 110 is closed by the lid member 120. In addition, the assembling worker attaches the oil seal 102 inside the rib 122 of the lid member 120 to finish assembling the inner cover unit 3B. Then, the assembling worker inserts the inner cover unit 3B thus assembled into the second housing room 2F of either right case 21 or left case 22.

In the state that the inner cover unit 3B is assembled, the gap between the inner surface of the cylindrical body 110 and the lid member 120 is closed with the O-ring 101. Also, in an area where the shaft body 31 is inserted into the large-diameter hole 123 of the lid member 120, the gap between the lid member 120 and the shaft body 31 has a cranked shape when viewed from the direction intersecting at the right angle with the diameter of the shaft body 31. This allows for reducing the chances that the lubricant leaks out of the gap between the lid member 120 and the shaft body 31 compared with a situation where the gap between the lid member 120 and the shaft body 31 is straight. Also, the oil seal 102 attached inside the rib 122 is brought into contact with the surface of the shaft body 31 of the output shaft 30, which further reduces the chances that the lubricant leaks out of the gap between the lid member 120 and the shaft body 31. Therefore, the inner cover unit 3B of a retaining ring fixing type (refer to FIGS. 10 and 11) reduces the chances that the lubricant filled in the inner cover unit 3B leaks out of the inner cover unit 3B. This allows for further reducing the chances that a lubricating effect of the lubricant deteriorates. In the inner cover unit 3B shown in FIGS. 10 and 11, the sealing member 100 is constituted by the O-ring 101 and the oil seal 102.

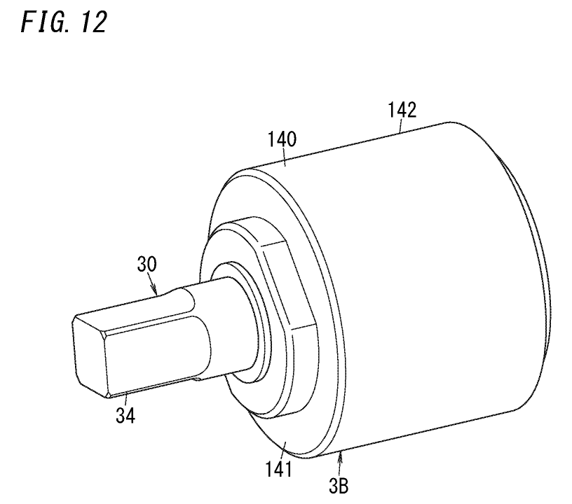

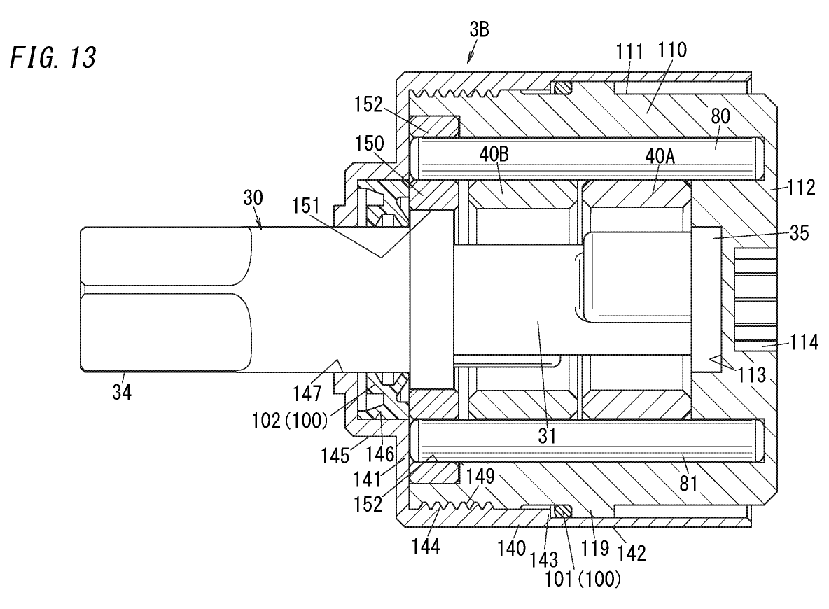

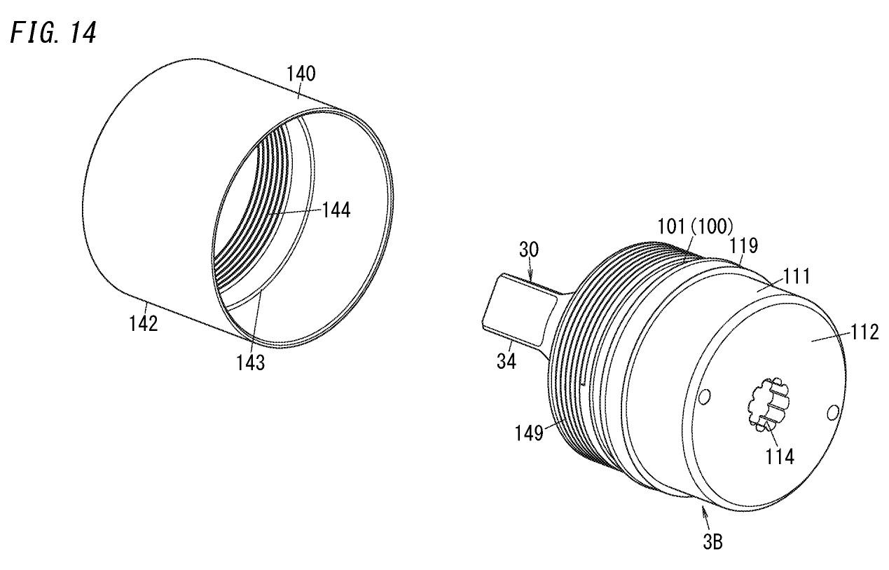

Also, a method for joining the cylindrical body 110 and the lid member 120 may also be a threaded case fixing method as shown in FIGS. 12–14. As used herein, the threaded case fixing method indicates a method for joining the cylindrical body 110 and the lid member 140 by screwing an external thread portion provided for one of the cylindrical body 110 and the lid member 140 into an internal thread portion provided for the other one of the cylindrical body 110 and the lid member 140. Note that the inner cover unit 3B shown in FIGS. 12–14 includes the same configuration as the inner cover unit 3B shown in FIGS. 8 and 9 except that the cylindrical body 110 and the lid member 140 are joined to each other by the threaded case fixing method. Therefore, constituent elements having the same feature will be designated by the same reference sign and description thereof will be omitted herein to avoid redundancy.

In the cylindrical body 110, an external thread portion 149 is provided for the front part of the outer peripheral surface of the circular cylindrical portion 111. Also, on the outer peripheral surface of the circular cylindrical portion 111, a projection 119 protruding outward in a radial direction is provided behind the external thread portion 149. The projection 119 extends along the circumference direction of the circular cylindrical portion 111.

The two cam pins 80 and 81, the two hammer member 40A and 40B, and the output shaft 30 are housed inside the cylindrical body 110. Also, a supporting plate 150 for supporting respective front end portions of the two cam pins 80 and 81 are housed inside the cylindrical body 110. A penetration hole 151 into which the shaft body 31 of the output shaft 30 is inserted and two penetration holes 152 into which the two cam pins 80 and 81 are respectively inserted are provided for the supporting plate 150.

The lid member 140 includes a circular cylindrical portion 142 into which the circular cylindrical portion 111 of the cylindrical body 110 is inserted and a front wall portion 141 closing the front end portion of the circular cylindrical portion 142. The lid member 140 is formed in the shape of a bottomed cylinder of which the front end portion is closed.

An internal thread portion 144 that engages with the external thread portion 149 of the cylindrical body 110 is provided in the inner side surface of the circular cylindrical portion 142. Also, a protruding portion 145 protruding forward is provided in the center of the front wall portion 141. A round hole 147 into which the output shaft 30 is inserted is provided in the center of the front surface of the protruding portion 145. The oil seal 102, serving as the sealing member 100, is disposed in a recess 146 inside the protruding portion 145 to close the gap between the output shaft 30 and the lid member 140 that perform rotational movements.

When assembling the inner cover unit 3B, first, the assembling worker puts the cam pins 80 and 81, the hammer members 40A and 40B, and the output shaft 30 inside the cylindrical body 110, and then fills the cylindrical body 110 with a lubricant. Thereafter, the assembling worker puts the supporting plate 150 in the cylindrical body 110. In this step, the output shaft 30 is inserted into the penetration hole 151 of the supporting plate 150, and the respective front end portions of the two cam pins 80 and 81 are inserted into the two penetration holes 152 of the supporting plate 150. Next, the assembling worker disposes, in the outer peripheral surface of the cylindrical body 110, the O-ring 101 in front of the projection 119 and also disposes the oil seal 102 in the recess 146 of the lid member 140. In this state, the assembling worker inserts the cylindrical body 110 into the circular cylindrical portion 142 of the lid member 140 from behind, and then inserts a front end portion of the output shaft 30 housed in the cylindrical body 110 into the round hole 147 of the lid member 140. Thereafter, the assembling worker turns the lid member 140 relative to the cylindrical body 110 to screw the external thread portion 149 of the cylindrical body 110 into the internal thread portion 144 of the lid member 140, thus the cylindrical body 110 and the lid member 140 are joined together. Finally, the assembling worker inserts the inner cover unit 3B thus assembled into the second housing room 2F of either right case 21 or left case 22.

In the state that the inner cover unit 3B is assembled, the external thread portion 149 of the cylindrical body 110 and the internal thread portion 144 of the lid member 140 engage with each other, thus the gap between the inner peripheral surface of the circular cylindrical portion 142 of the lid member 140 and the outer peripheral surface of the cylindrical body 110 is closed. Also, the O-ring 101 is disposed between the inner peripheral surface of the circular cylindrical portion 142 of the lid member 140 and the outer peripheral surface of the cylindrical body 110, thus the gap between the inner peripheral surface of the circular cylindrical portion 142 of the lid member 140 and the outer peripheral surface of the cylindrical body 110 is closed by the O-ring 101 forming a seal at the interface. In addition, the oil seal 102 attached inside the recess 146 of the lid member 140 is brought into contact with the surface of the shaft body 31 of the output shaft 30, which reduces the chances that the lubricant leaks out of the gap between the lid member 140 and the shaft body 31. Therefore, the inner cover unit 3B of the threaded case fixing type (shown in FIGS. 12–14) also allows for reducing the chances that the lubricant filled in the inner cover unit 3B leaks out of the inner cover unit 3B. This allows for further reducing the chances that a lubricating effect of the lubricant deteriorates. In the inner cover unit 3B shown in FIGS. 12–14, the sealing member 100 is constituted by the O-ring 101 and the oil seal 102.

Note that the configuration of the second variation may be applied to the impact rotary

tool 1 according to the first variation. Sealing the inner cover unit 3A with the sealing member 100 reduces the chances that the lubricant filled in the inner cover unit 3A leaks out.

(3.3) Third Variation

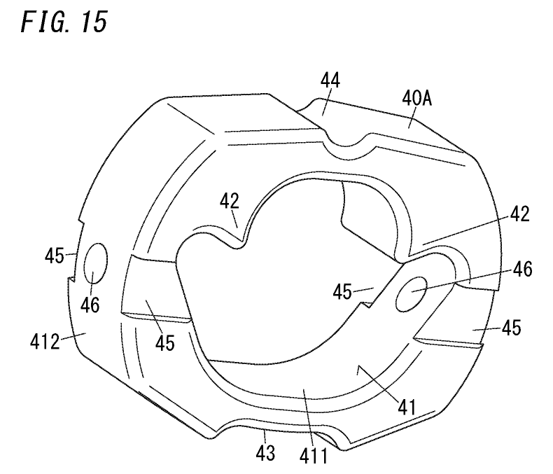

Hammer members 40A and 40B included in an impact rotary tool 1 according to a third variation will be described with reference to FIG. 15. In the impact rotary tool 1 according to the third variation, the hammer members 40A and 40B is provided with a communicating portion for connecting an inner surface 411 and outer surface 412 of a cylindrical body (i.e., the hammer members 40A and 40B), which is a difference from the impact rotary tool 1 according to the basic configuration. In the third variation, the respective inner surfaces 411 of the hammer members 40A and 40B refer to the wall surfaces of insertion holes 41 provided for the hammer members 40A and 40B, and the respective outer surfaces 412 of the hammer members 40A and 40B refer to the side surfaces of the hammer members 40A and 40B having the shape of a hollow cylinder. Note that the impact rotary tool 1 according to the third variation includes the same configuration as the basic configuration except that the communicating portion is provided for each of the hammer members 40A and 40B, and therefore, constituent elements of the impact rotary tool 1 according to the third variation having the same feature as the basic configuration will be designated by the same reference sign and description thereof will be omitted herein to avoid redundancy.

In the impact rotary tool 1 according to the basic configuration, as described in “(2.3) Description of operations,” once the inner cover unit 3 has started rotating in response to the rotation of the rotary shaft 11 of the motor 10, the hit portions 32 and 33 of an output shaft 30 is respectively hit by the hitting portion 42 of the hammer members 40A and 40B housed in the inner cover unit 3. For example, when the hitting portion 42 of the hammer member 40A hits the hit portion 32 of the output shaft 30, the hammer member 40A swings around a cam pin 81 (serving as the second cam pin), thus the hitting portion 42 climbs over the hit portion 32. In that step, suppose that a lubricant is filled inside an inner cover unit 3, the lubricant provided between the inner surface of the inner cover unit 3 and the hammer member 40A could act, depending on viscosity or consistency of the lubricant, as resistance with respect to the swings of the hammer member 40A when the hammer member 40A is about to swing around a cam pin 81. This could inhibit swings of the hammer member 40A. If the swings of the hammer member 40A around the cam pin 81 are inhibited, then the hitting portion 42 of the hammer member 40A is no longer able to climb over the hit portion 32. This possibly causes a situation where the impact mechanism 4 including the hammer member 40A is locked.

Therefore, in the hammer member 40A included in the impact rotary tool 1 according to the third variation, the communicating portion for connecting the inner surface 411 and outer surface 412 of the hammer member 40A is provided in a direction intersecting with a direction aligned with the axis of the output shaft 30. The lubricant may move (pass) through this communicating portion. In that case, the communicating portion provided for the hammer member 40A may include a recess groove 45 provided in the surface of the hammer member 40A and/or a penetration hole 46 penetrating through the hammer member 40A.

For example, the hammer member 40A shown in FIG. 15 has the shape of a hollow cylinder having an oval shape when viewed from the axial direction of the output shaft 30. As the communicating portion, the two recess grooves 45 and the penetration hole 46 are provided for each of two portions arranged to align with a direction intersecting with a direction defined by connecting a first groove 43 and a second groove 44.

The two recess grooves 45 are respectively provided in surfaces on the both sides of the hammer member 40A with respect to the axial direction of the output shaft 30. Each of the two recess grooves 45 extends along a direction intersecting with the axial direction of the output shaft 30 and intersecting with a direction defined by connecting the first groove 43 and the second groove 44. Each of the two recess grooves 45 is provided for the hammer member 40A having the shape of a hollow cylinder to extend from the inner surface 411 to the outer surface 412.

Also, the penetration hole 46 is provided to penetrate through the hammer member 40A along a direction intersecting with the axial direction of the output shaft 30 and intersecting with a direction defined by connecting the first groove 43 and the second groove 44. One end of the penetration hole 46 opens to the inner surface 411 and the other end of the penetration hole 46 opens to the outer surface 412.

In the impact rotary tool 1 according to the third variation, if the hammer member 40A swings around the cam pin 81 (serving as the second cam pin) when the hitting portion 42 of the hammer member 40A hits the hit portion 32 of the output shaft 30 in response to the rotation of the inner cover unit 3, the lubricant provided between the inner surface of the inner cover unit 3 and the hammer member 40A may flow (pass) through the two recess grooves 45 and the penetration hole 46. This reduces the chances that the lubricant, which is provided between the inner surface of the inner cover unit 3 and the hammer member 40A, acts as a wall (as resistance), thus allowing for avoiding a situation where the hammer member 40A less easily swings around the cam pin 81. This reduces the chances that the impact mechanism 4 is locked.

The hammer member 40A shown in FIG. 15 is provided with the two recess grooves 45 and the penetration hole 46. However, the hammer member 40A does not have to be provided with all of the two recess grooves 45 and the penetration hole 46. Alternatively, the number and the shape of communicating portions provided for the hammer member 40A may be changed as appropriate.

Note that the hammer member 40B may also be provided with the same communicating portion (e.g., the recess groove 45 and the penetration hole 46) as in the hammer member 40A. This allows for reducing the chances that the impact mechanism 4 is locked.

Also, the communicating portion (e.g., the recess groove 45 and the penetration hole 46) described in the third variation may be provided for the hammer members 40A and 40B included in the impact rotary tool 1 according to the first variation or the second variation, which allows for reducing the chances that the impact mechanism 4 is locked.

(3.4) Fourth Variation

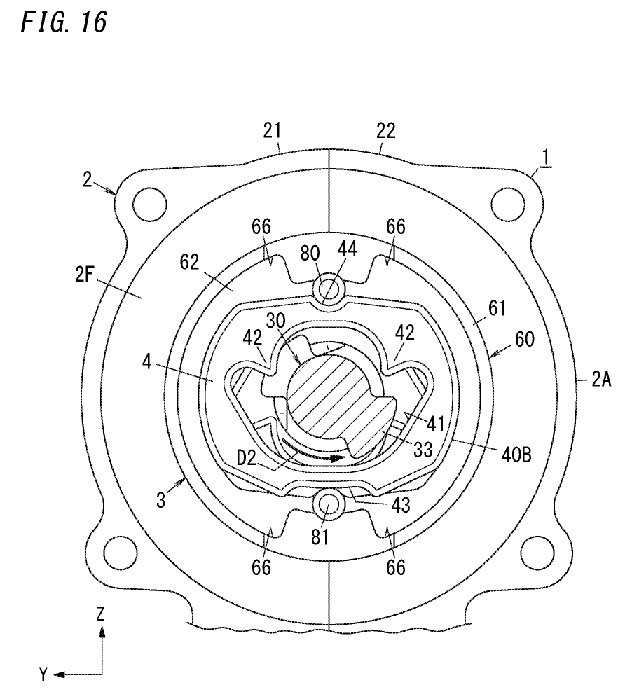

An impact rotary tool 1 according to a fourth variation will be described with reference to FIG. 16. In the impact rotary tool 1 according to the fourth variation, a recess portion 66 is provided for the inner cover unit 3 in an area that faces a first groove 43 in a direction intersecting with the axial direction of the output shaft 30, which is a difference from the impact rotary tool 1 according to the basic configuration. Note that the impact rotary tool 1 according to the fourth variation includes the same configuration as the basic configuration except that the recess portion 66 is provided in the inner surface of the inner cover unit 3, and therefore, constituent elements of the impact rotary tool 1 according to the fourth variation having the same feature as the basic configuration will be designated by the same reference sign and description thereof will be omitted herein to avoid redundancy.

In the impact rotary tool 1 according to the fourth variation, the recess portion 66 is provided in the inner surface of the inner cover unit 3 at a position in the vicinity of a cam pin 80 (serving as the first cam pin) inserted into the first groove 43 of a hammer member 40A and a position in the vicinity of a cam pin 81 (serving as the first cam pin) inserted into the first groove 43 of a hammer member 40B. More particularly, in the inner surface of each of the first cylindrical body 60 and the second cylindrical body 70, the recess portions 66 are respectively provided in the vicinity of the cam pins 80 and 81.

In the impact rotary tool 1 according to the fourth variation, if the hammer member 40B swings around the cam pin 80 (serving as the second cam pin) when a hitting portion 42 of the hammer member 40B hits a hit portion 33 of the output shaft 30 in response to the rotation of the inner cover unit 3, a lubricant provided between the inner surface of the inner cover unit 3 and the hammer member 40B may flow in the recess portion 66 located in the vicinity of the cam pin 81 (serving as the first cam pin). This reduces the chances that the lubricant, which is provided between the inner surface of the inner cover unit 3 and the hammer member 40B, acts as a wall (as resistance), thus allowing for avoiding a situation where the hammer member 40B less easily swings around the cam pin 80 (serving as the second cam pin). This reduces the chances that the impact mechanism 4 is locked.

In the same manner, if the hammer member 40A swings around the cam pin 81 (serving as the second cam pin) when the hitting portion 42 of the hammer member 40A hits a hit portion 32 of the output shaft 30 in response to the rotation of the inner cover unit 3, a lubricant provided between the inner surface of the inner cover unit 3 and the hammer member 40A may flow in the recess portion 66 located in the vicinity of the cam pin 80 (serving as the first cam pin). This reduces the chances that the lubricant, which is provided between the inner surface of the inner cover unit 3 and the hammer member 40A, acts as a wall (as resistance), thus allowing for avoiding a situation where the hammer member 40A less easily swings around the cam pin 81 (serving as the second cam pin). This reduces the chances that the impact mechanism 4 is locked.

Note that the configuration of the fourth variation may be applied to the impact rotary tool 1 according to any of the first to third variations, which allows for reducing the chances that the impact mechanism 4 is locked.

(3.5) Other variations

An impact rotary tool 1 may also include an outer shell (not shown) further covering the outside of a body case 2.

The impact rotary tool 1 according to the basic configuration and the first variation includes the two hammer members 40A and 40B. However, this should not be construed as limiting. Alternatively, an impact rotary tool 1 may include only one hammer member. In this case, the output shaft 30 only need to be provided with one hit portion that is to be hit by the hitting portion of the hammer member.

The inner cover unit 3 is constituted by two members (namely, the first circular cylindrical body 60 and the second cylindrical body 70). However, this should not be construed as limiting. Alternatively, the inner cover unit 3 may also be constituted by equal to or more than three members. The same statement applies to the inner cover unit 3A constituted by two members (namely, the first cylindrical body 90 and the second cylindrical body 95). The inner cover unit 3A may also be constituted by equal to or more than three members.

In the basic configuration and the first variation, the shaft body 31 forms an integral part of the output shaft 30. However, this should not be construed as limiting. Alternatively, the output shaft 30 is constituted by joining a first member for which the hit portions 32 and 33 is provided and a second member for which the connecting portion 34 is provided.

### (Recapitulation)

The exemplary embodiment and its variations described above are specific implementations of the following aspects of the present disclosure.

An impact rotary tool (1) according to a first aspect includes a motor (10), an output shaft (30) to which a tip tool (T1) is attachable, an impact mechanism (4), an inner cover unit (3, 3A, 3B), and a body case (2). The impact mechanism (4) is configured to apply impacting force to the output shaft (30) in response to rotation of the motor (10). The body case (2) houses the motor (10), the impact mechanism (4), and the inner cover unit (3, 3A, 3B). The impact mechanism (4) includes a hammer member (40A, 40B) that hits, in response to the rotation of the motor (10), hit portion (32, 33) provided for the output shaft (30). The inner cover unit (3, 3A, 3B) covers at least the impact mechanism (4).

According to this aspect, since the inner cover unit (3, 3A, 3B) housed in the body case (2) covers the impact mechanism (4), the impact mechanism (4) are double-covered by the inner cover unit (3, 3A, 3B) and the body case (2). This allows for reducing the hitting sound transmitted to the outside of the body case (2) if a hitting sound is generated when the hammer members (40A, 40B) hit the hit portions (32, 33).

In an impact rotary tool (1) according to a second aspect, which may be implemented in conjunction with the first aspect, the inner cover unit (3) is configured to rotate in response to rotation of a rotary shaft (11) of the motor (10).

According to this aspect, energy generated by the impact can be converted into inertial energy by the rotation of the inner cover unit (3), which allows for increasing the output torque.

In an impact rotary tool (1) according to a third aspect, which may be implemented in conjunction with the first aspect, the inner cover unit (3A, 3B) is fixed to the body case (2).

This aspect can reduce the load applied to the motor (10) compared with a situation where the inner cover unit (3A, 3B) rotates in response to the rotation of the rotary shaft (11) of the motor (10).

In an impact rotary tool (1) according to a fourth aspect, which may be implemented in conjunction with any one of the first to third aspects, the inner cover unit (3, 3A, 3B) is constituted by multiple members assembled together.

This aspect allows for making it easier to perform the operations to put the impact mechanism (4) inside the inner cover unit (3, 3A, 3B).

An impact rotary tool (1) according to a fifth aspect, which may be implemented in conjunction with any one of the first to fourth aspects, further includes a lubricant filled inside the inner cover unit (3, 3A, 3B).

According to this aspect, the inner cover unit (3, 3A, 3B) covering the impact mechanism (4) allows for reducing the chances that the lubricant filled in the impact mechanism (4) splashes, which makes it less easy for a lubricating effect of the lubricant to deteriorate. This reduces the chances that the members belonging to the impact mechanism (4) deteriorate.

An impact rotary tool (1) according to a sixth aspect, which may be implemented in conjunction with the fifth aspect, further includes a sealing member (100) for sealing the inner cover unit (3, 3A, 3B).

This aspect further reduces the chances that the lubricant filled in the inner cover unit (3, 3A, 3B) leaks out of the inner cover unit (3, 3A, 3B). This allows for further reducing the chances that the lubricating effect of the lubricant deteriorates.

In an impact rotary tool (1) according to a seventh aspect, which may be implemented in conjunction with the fifth or sixth aspect, the hammer member (40A, 40B) has a shape of a hollow cylinder and is provided with an insertion hole (41) into which the output shaft (30) is inserted. The hammer member (40A, 40B) is provided with a communicating portion (45, 46) for connecting an inner surface (411) and outer surface (412) of the hammer member (40A, 40B).

According to this aspect, the lubricant provided between the inner surface of the inner cover unit (3, 3A, 3B) and the hammer member (40A, 40B) may pass through the communicating portion (45, 46) when the hammer member (40A, 40B) hits the hit portion (32, 33). Therefore, this aspect achieves the advantage of reducing the chances that the lubricant provided between the inner surface of the inner cover unit (3, 3A, 3B) and the hammer member (40A, 40B) inhibits movements of the hammer member (40A, 40B).

In an impact rotary tool (1) according to an eighth aspect, which may be implemented in conjunction with any one of the fifth to seventh aspects, a first groove (43) and a second groove (44), into which a first cam pin (80, 81) and a second cam pin (81, 80) fixed to the inner cover unit (3, 3A, 3B) are respectively inserted, are provided for the hammer member (40A, 40B). The first groove (43) is formed to have a width larger than a diameter of the first cam pin (80, 81). The hammer member (40A, 40B) is allowed to swing around the second cam pin (81, 80) inserted into the second groove (44) within a range that the first cam pin (80, 81) is allowed to move within the first groove (43). A recess portion (66) is provided for the inner surface of the inner cover unit (3, 3A, 3B) in an area that faces the first groove (43) in a direction intersecting with an axial direction of the output shaft (30).

According to this aspect, the lubricant provided between the inner surface of the inner cover unit (3, 3A, 3B) and the hammer member (40A, 40B) may flow through the recess portion (66) when the hammer member (40A, 40B) hits the hit portion (32, 33). Therefore, this aspect achieves the advantage of reducing the chances that the lubricant provided between the inner surface of the inner cover unit (3, 3A, 3B) and the hammer member (40A, 40B) acts as resistance and inhibits movements of the hammer member (40A, 40B).

In an impact rotary tool (1) according to a ninth aspect, which may be implemented in conjunction with any one of the first to eighth aspects, a pair of the hit portions (32, 33) are respectively provided on the output shaft (30) in positions symmetrical with respect to a rotational axis of the output shaft (30). The impact mechanism (4) includes a pair of the hammer members (40A, 40B) correspond one to one to the pair of the hit portions (32, 33). Each of the pair of the hammer members (40A, 40B) hits, in response to rotation of the motor (10), a corresponding one of the pair of the hit portions (32, 33).

This aspect allows for applying impacting force equally to the two hit portions (32, 33) by the two hammer members (40A, 40B) that hit the two hit portions (32, 33) provided respectively in positions symmetrical with respect to the rotational axis of the output shaft (30). In this manner, the two hammer members (40A, 40B) hit the two hit portions (32, 33) of the output shaft (30), which enables the output shaft (30) to rotate smoothly.

Note that the features according to the second to ninth aspects are not essential for the impact rotary tool (1) but may be omitted as appropriate.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An impact rotary tool comprising:
a motor;
an output shaft to which a tip tool is attachable;
an impact mechanism configured to apply impacting force to the output shaft in response to rotation of the motor;
an inner cover unit; and
a body case housing the motor, the impact mechanism, and the inner cover unit,
the impact mechanism including a hammer member that hits, in response to the rotation of the motor, hit portion provided for the output shaft, and
the inner cover unit covering at least the impact mechanism.

2. The impact rotary tool of claim 1, wherein
the inner cover unit is configured to rotate in response to rotation of a rotary shaft of the motor.

3. The impact rotary tool of claim 1, wherein
the inner cover unit is fixed to the body case.

4. The impact rotary tool of claim 1, wherein
the inner cover unit is constituted by multiple members assembled together.

5. The impact rotary tool of claim 1, further comprising a lubricant filled inside the inner cover unit.

6. The impact rotary tool of claim 5, further comprising a sealing member for sealing the inner cover unit.

7. The impact rotary tool of claim 5, wherein
the hammer member has a shape of a hollow cylinder and is provided with an insertion hole into which the output shaft is inserted, and
the hammer member is provided with a communicating portion for connecting an inner surface and outer surface of the hammer member.

8. The impact rotary tool of claim 5, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.

9. The impact rotary tool of claim 1, wherein
a pair of the hit portions are respectively provided on the output shaft in positions symmetrical with respect to a rotational axis of the output shaft,
the impact mechanism includes a pair of the hammer members that correspond one to one to the pair of the hit portions, and
each of the pair of the hammer members hits, in response to the rotation of the motor, a corresponding one of the pair of the hit portions.

10. The impact rotary tool of claim 2, wherein
the inner cover unit is constituted by multiple members assembled together.

11. The impact rotary tool of claim 3, wherein
the inner cover unit is constituted by multiple members assembled together.

12. The impact rotary tool of claim 2, further comprising a lubricant filled inside the inner cover unit.

13. The impact rotary tool of claim 3, further comprising a lubricant filled inside the inner cover unit.

14. The impact rotary tool of claim 4, further comprising a lubricant filled inside the inner cover unit.

15. The impact rotary tool of claim 6, wherein
the hammer member has a shape of a hollow cylinder and is provided with an insertion hole into which the output shaft is inserted, and
the hammer member is provided with a communicating portion for connecting an inner surface and outer surface of the hammer member.

16. The impact rotary tool of claim 6, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.

17. The impact rotary tool of claim 7, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.

18. The impact rotary tool of claim 2, wherein
a pair of the hit portions are respectively provided in positions symmetrical with respect to a rotational axis of the output shaft,
the impact mechanism includes a pair of the hammer members that correspond one to one to the pair of the hit portions, and
each of the pair of the hammer members hits, in response to the rotation of the motor, a corresponding one of the pair of the hit portions.

19. The impact rotary tool of claim 3, wherein
a pair of the hit portions are respectively provided on the output shaft in positions symmetrical with respect to a rotational axis of the output shaft,
the impact mechanism includes a pair of the hammer members that correspond one to one to the pair of the hit portions, and
each of the pair of the hammer members hits, in response to the rotation of the motor, a corresponding one of the pair of the hit portions.

20. The impact rotary tool of claim 4, wherein
a pair of the hit portions are respectively provided on the output shaft in positions symmetrical with respect to a rotational axis of the output shaft,
the impact mechanism includes a pair of the hammer members that correspond one to one to the pair of the hit portions, and
each of the pair of the hammer members hits, in response to the rotation of the motor, a corresponding one of the pair of the hit portions.
